(19) United States
(12) Patent Application Publication
(10) Pub. No.: US 2020/0241810 A1
(43) Pub. Date: Jul. 30, 2020

(54) IMAGE FORMING SYSTEM, IMAGE FORMING APPARATUS, IMAGE FORMING METHOD, AND RECORDING MEDIUM

(71) Applicant: KYOCERA Document Solutions Inc., Osaka-shi (JP)

(72) Inventors: Shinichi HASHIMOTO, Osaka-shi (JP); Akihiko IKAZAKI, Osaka-shi (JP); Kunihiko SHIMAMOTO, Osaka-shi (JP)

(21) Appl. No.: 16/750,221

(22) Filed: Jan. 23, 2020

(30) Foreign Application Priority Data
Jan. 30, 2019 (JP) 2019-014538

(51) Int. Cl. G06F 3/12

(52) U.S. Cl. CPC G06F 3/126; G06F 3/1291; G06F 3/1232; G06F 3/1203; G06F 3/123

(57) ABSTRACT

An image forming system includes a plurality of image forming apparatuses connectable to a network. Each of the plurality of image forming apparatuses includes an operation display unit having a menu configuration unified among the plurality of image forming apparatuses, and a control unit to control the operation display unit. The operation display unit displays a function executable by at least one of the plurality of image forming apparatuses. When processing with a function executable by one image forming apparatus including the operation display unit is instructed, the control unit causes the one image forming apparatus to execute the function. When processing with a function not executable by the one image forming apparatus including the operation display unit is instructed, the control unit causes another image forming apparatus capable of executing the function by proxy to execute the function.

### INCORPORATION BY REFERENCE

This application is based upon and claims the benefit of priority from the corresponding Japanese Patent Application No. 2019-014538 filed on Jan. 30, 2019, the entire contents of which are incorporated herein by reference.

### BACKGROUND

The present disclosure relates to an image forming system, an image forming apparatus, an image forming method, and a recording medium.

A typical image forming apparatus can perform various processes such as image formation on a print medium, FAX transmission, and transmission of scan data.

On the other hand, it is also common to install a plurality of types of image forming apparatuses in an office.

The image forming apparatuses of a plurality of models have different specifications, and the available functions are different, and the operation display menus are different, and the software programs to be installed are often different from each other.

There has been proposed a technology in which location information of a printer driver program stored in a printing apparatus is acquired for an image forming apparatus (an example of a data processing apparatus) of various specifications, and the data processing apparatus downloads a specific printer driver program from the server apparatus according to the location information.

According to this technique, it is possible to freely construct a printer driver installation environment in which the installation process can be completed by securely acquiring the printer driver program which is most suitable for the printing apparatus from a specific server apparatus which manages the printer driver program, so that it is possible to reduce the installation load at the time when the data processing apparatus is newly introduced.

### SUMMARY

An image forming system according to this disclosure includes a plurality of image forming apparatuses connectable to a network. Each of the plurality of image forming apparatuses includes an operation display unit having a menu configuration unified among the plurality of image forming apparatuses and a control unit to control the operation display unit. The operation display unit displays a function executable by at least one of the plurality of image forming apparatuses. When processing with a function executable by the one image forming apparatus including the operation display unit is instructed, the control unit causes the one image forming apparatus to execute the function. When processing with a function not executable by the one image forming apparatus including the operation display unit is instructed, the control unit causes another image forming apparatus capable of executing the function by proxy to execute the function.

An image forming apparatus according to this disclosure is connectable to a network and includes an operation display unit, a storage unit, and a control unit. The operation display unit has a predetermined menu configuration. The storage unit stores model information indicating a function executable by the image forming apparatus. The control unit controls the operation display unit. The control unit queries at least one different image forming apparatus connected to the network about model information to specify a proxy possible function that is a function not executable by the image forming apparatus but executable by the at least one different image forming apparatus, and returns, according to a query from a different image forming apparatus, information indicating a function executable by the image forming apparatus based on the model information. The predetermined menu configuration is unified with a menu configuration of an operation display unit of the different image forming apparatus and allows the proxy possible function, which has been specified, to be executed by the at least one different image forming apparatus.

An image forming method according to this disclosure uses an image forming apparatus connectable to a network and includes displaying and storing. In the displaying, a predetermined menu configuration is used. In the storing, model information indicating a function executable by the image forming apparatus is stored. The displaying includes querying at least one different image forming apparatus connected to the network about model information to specify a proxy possible function that is a function not executable by the image forming apparatus but executable by the at least one different image forming apparatus. The displaying also includes returning, according to a query from a different image forming apparatus about model information, information indicating a function executable by the image forming apparatus based on the model information. The predetermined menu configuration is unified with a menu configuration used for displaying on the different image forming apparatus and allows the proxy possible function, which has been specified, to be executed by the at least one different image forming apparatus.

A non-transitory computer-readable recording medium according to this disclosure stores a control program for controlling an image forming apparatus connectable to a network. The control program causes the image forming apparatus to serve as an operation display unit having a predetermined menu configuration, a storage unit to store model information indicating a function executable by the image forming apparatus, and a control unit to control the operation display unit. The control unit queries at least one different image forming apparatus connected to the network about model information to specify a proxy possible function that is a function not executable by the image forming apparatus but executable by the at least one different image forming apparatus, and returns, according to a query from a different image forming apparatus about model information, information indicating a function executable by the image forming apparatus based on the model information. The predetermined menu configuration is unified with a menu configuration of an operation display unit of the different image forming apparatus and allows the proxy possible function, which has been specified, to be executed by the at least one different image forming apparatus.

### BRIEF DESCRIPTION OF THE DRAWINGS

FIG. 1 is a schematic configuration diagram showing an overall configuration of an image forming system according to an embodiment of the present disclosure.

FIG. 2 is a schematic configuration diagram showing an image forming apparatus according to one embodiment.

FIG. 3 is a table showing various functions of three image forming apparatuses according to one embodiment.

FIG. 4 is an explanatory diagram showing a control program group according to one embodiment.

FIG. 5 is a flowchart showing the contents of automatic installation processing according to one embodiment.

FIG. 6 is a flowchart showing the contents of system activation processing according to one embodiment.

FIGS. 7A, 7B and 7C are explanatory diagrams showing the display contents of operation display units of three image forming apparatuses according to one embodiment.

FIG. 8 is a flowchart showing the contents of data transmission processing according to one embodiment.

FIGS. 9A and 9B are explanatory diagrams each showing an example of display contents of an operation display unit that are displayed in data transmission processing according to one embodiment.

### DETAILED DESCRIPTION

Hereinafter, a mode for implementing the present disclosure (hereinafter referred to as “embodiment”) will be described with reference to the drawings.

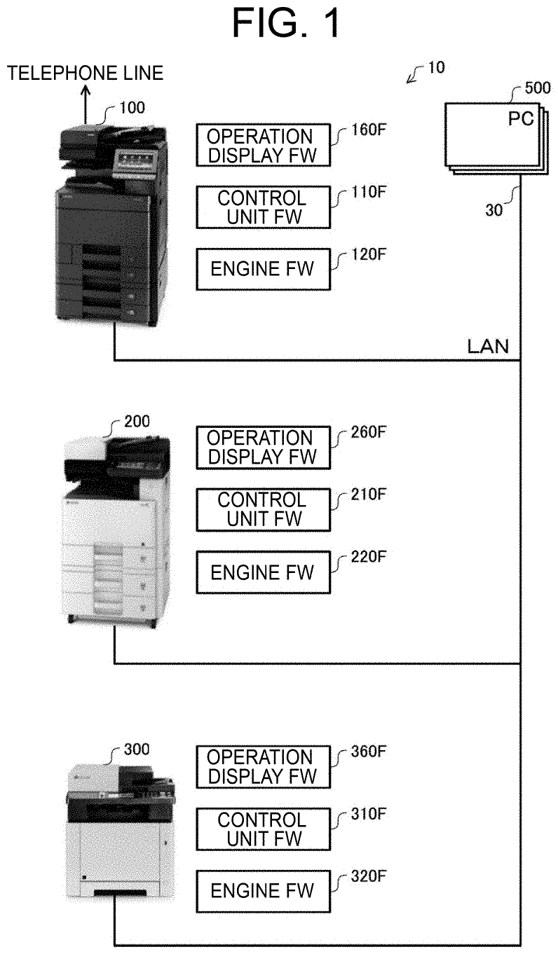

FIG. 1 is a schematic configuration diagram showing an overall configuration of an image forming system 10 according to an embodiment of the present disclosure.

In the present embodiment, the image forming system 10 includes three image forming apparatuses 100, 200, and 300, and a local area network (also referred to simply as LAN) 30 that connects the image forming apparatuses 100, 200, and 300 to each other.

That is, the image forming system 10 is configured such that a plurality of image forming apparatuses 100, 200, and 300 are connected to each other via the LAN 30.

The three image forming apparatuses 100, 200, and 300 are different from each other in configuration.

A plurality of personal computers 500 are also connected to the LAN 30.

Further, a telephone line is connected to the image forming apparatus 100.

Thus, the image forming apparatus 100 is capable of transmitting and receiving faxes.

A control program is installed in the three image forming apparatuses 100, 200, and 300 using a common control program group 400 (to be described later).

In the image forming apparatus 100, operation display firmware (also referred to as “operation display FW”) 160F, control unit firmware (also referred to as “control unit FW”) 110F, and engine firmware (also referred to as “engine FW”) 120F are installed.

In the image forming apparatus 200, operation display firmware 260F, control unit firmware 210F, and engine firmware 220F are installed.

In the image forming apparatus 300, operation display firmware 360F, control unit firmware 310F, and engine firmware 320F are installed.

Firmware is included in the control program.

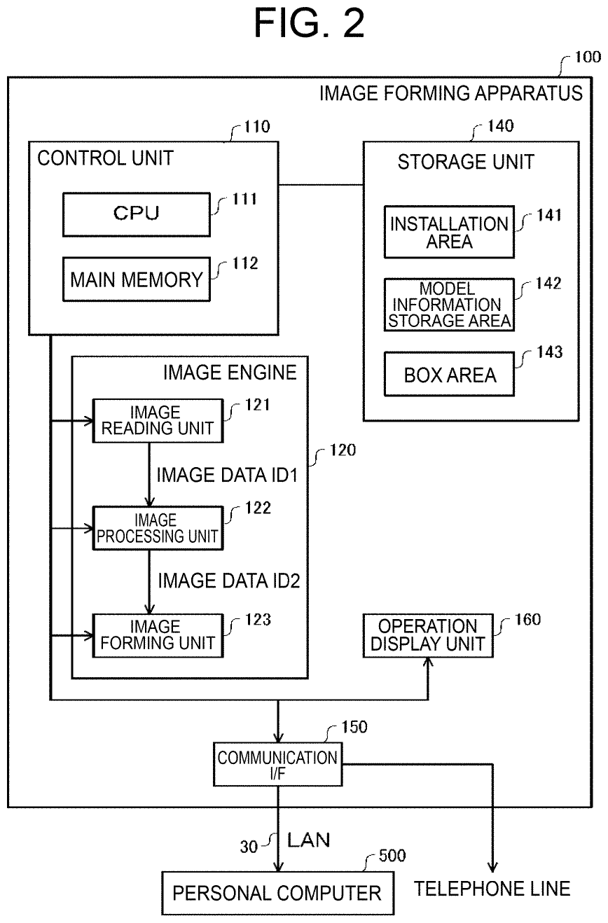

FIG. 2 is a schematic configuration diagram showing an image forming apparatus 100 according to one embodiment.

The image forming apparatus 100 includes a control unit 110, an image reading unit 121, an image processing unit 122, an image forming unit 123, a storage unit 140, a communication interface unit (also referred to as “communication I/F”) 150, and an operation display unit 160.

The communication interface unit 150 is connectable to other image forming apparatuses 200 and 300 and a plurality of personal computers 500 via a LAN 30 by using a Transmission Control Protocol/Internet Protocol (TCP/IP) protocol group, for instance.

The communication interface unit 150 is also connected to a telephone line.

The control unit 110 includes a central processing unit (CPU) 111 and a main memory 112.

The main memory 112 is composed of a random access memory (RAM).

The CPU 111 executes various processes in the main memory 112.

The control unit 110 has a controller function associated with various I/Os, universal serial buses (USBs), buses, and other interfaces for hardware and the like.

The control unit 110 controls the entire image forming apparatus 100.

The image reading unit 121 reads an image from a document to generate image data ID1 which is digital data.

The image processing unit 122 performs image processing (for example, background processing or contour enhancement processing) on the image data ID1 to generate image data ID2.

The image forming unit 123 executes color conversion processing and halftone processing on the image data to generate dot data, and forms an image on a printing medium (not shown) based on the dot data.

The image reading unit 121, the image processing unit 122, and the image forming unit 123 constitute an image engine 120.

The storage unit 140 is a storage device composed of a hard disk drive which is a non-transitory nonvolatile recording medium.

The storage unit 140 includes an installation area 141, a model information storage area 142, and a BOX area 143.

The installation area 141 is an area in which a control program customized based on the model information storage area 142 and using the control program group 400 (to be described later) is installed.

The operation display unit 160 serves as a touch panel, and displays various menus as input screens to accept user's operation input.

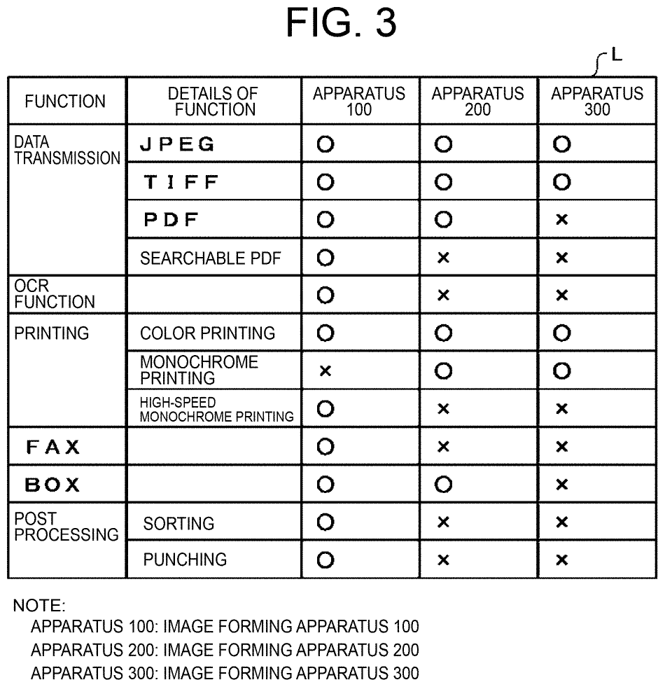

FIG. 3 is a table showing various functions of three image forming apparatuses according to one embodiment.

The model information storage area 142 stores model information which is information unique to the model of the image forming apparatus 100.

Information unique to the model includes information indicating the function of the image forming apparatus 100, and includes, for example, the following information.

(1) The presence/absence of data transmission function (file format specified in operation mode information)

(2) The presence/absence of the OCR function

(3) The presence/absence of the printing function: the color association or monochrome only (specified in operation mode information)

(4) The presence/absence of the FAX function

(5) The presence/absence of the BOX function

(6) The presence/absence of the post-processing function

In this example, the model information storage area 142 stores model information indicating the presence/absence of the data transmission function, the presence/absence of the character recognition function (OCR function), the presence/absence of the printing function, the presence/absence of the FAX function, the presence/absence of the BOX function, and the presence/absence of the post-processing function.

The data transmission function is a function of converting scan data into a data file of a predetermined file format (for example, JPEG), and transmitting the data file to a designated mail address.

As in this example, the model information may include, for example, one that specifies the presence or absence of the post-processing apparatus such as sorting, punching apparatus, stapler or the like.

The operation mode information indicates, in this example, the file format available in the data transmission function and whether the operation mode of the printer driver 410 is to be either color or monochrome.

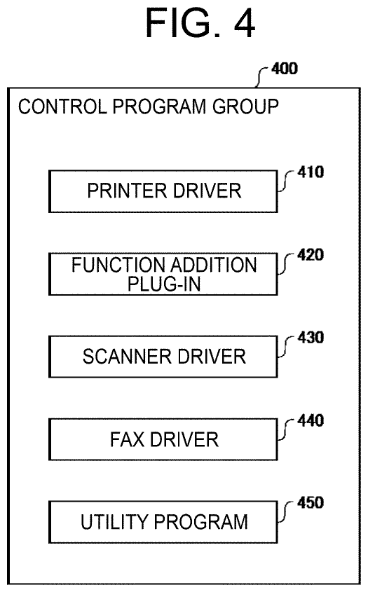

FIG. 4 is an explanatory diagram showing a control program group 400 according to one embodiment.

The control program group 400 includes a printer driver 410, a function addition plug-in 420, a scanner driver 430, a FAX driver 440, and a utility program 450.

It is assumed that the printer driver 410 has a plurality of operation modes of operation and a plurality of operation modes including only monochrome operation modes, and that the operation mode is set on the basis of the operation mode information at the time of installation.

In this example, the function addition plug-in 420 includes a program for realizing a data transmission function.

The program includes a program for converting scan data into a PDF file, and a program for transmitting a PDF file to a predetermined mail address.

The utility program 450 is a program for realizing the OCR function and the BOX function.

The control program group 400 is configured so that it can be shared among a plurality of image forming apparatuses (including three image forming apparatuses 100, 200, and 300) provided by the supplier of the image forming apparatus 100.

Accordingly, the supplier of the image forming apparatus 100 can realize simplification of distribution (provision) of the driver program, and can quickly respond to environmental changes or the like.

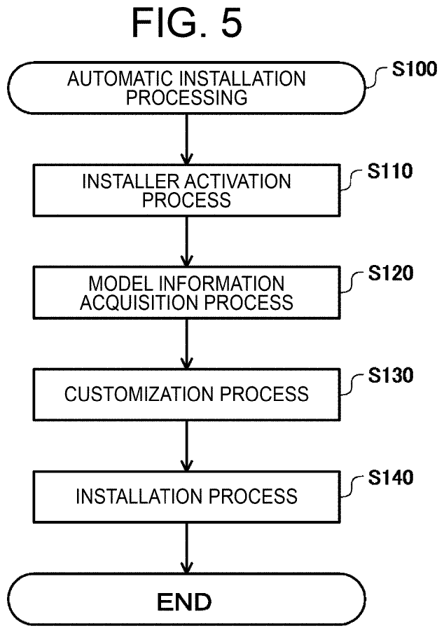

FIG. 5 is a flowchart showing the contents of automatic installation processing (step S100) according to one embodiment.

The automatic installation processing is started by acquiring the latest control program group 400 via download from a recording medium such as a digital versatile disc (DVD) or a server on the Internet, and according to the instruction of the user.

In step S110, the image forming apparatus 100 executes an installer activation process.

The user instructs the image forming apparatus 100 to start the automatic installation processing via the operation display unit 160.

Installation is to be performed in the installation area 141 of the storage unit 140.

In step S120, the control unit 110 of the image forming apparatus 100 executes a model information acquisition process.

In the model information acquisition process, the control unit 110 acquires model information stored in the model information storage area 142.

The model information is information unique to the model of the image forming apparatus 100.

The information unique to the model includes information indicating a function which can be executed by the image forming apparatus 100.

In step S130, the control unit 110 serves as a control program configuration unit and executes a customization process.

In the customization process, the control unit 110 extracts the printer driver 410, the function addition plug-in 420, the scanner driver 430, and the utility program 450 from the control program group 400 based on the model information.

In this example, since the image forming apparatus 100 has a FAX function, the FAX driver 440 is also extracted.

In step S140, the control unit 110 installs the printer driver 410, the function addition plug-in 420, the scanner driver 430, the FAX driver 440, and the utility program 450 in the installation area 141.

The control unit 110 sets the installed printer driver 410 to the color mode (for example, validates the color function), and installs four programs for converting the scan data in the function addition plug-in 420 into the JPEG file, the TIFF file, the PDF file, and the searchable PDF file, and a program for transmitting each data file to the predetermined mail address.

Further, the control unit 110 installs the scanner driver 430 and the utility program 450 in the installation area 141.

Thereby, the control units 110, 210, and 310 of the three image forming apparatuses 100, 200, and 300 are controlled by the control unit firmware 110F, the control unit firmware 210F, and the control unit firmware 310F, respectively.

The image engines 120, 220, and 320 are controlled by the engine firmware 120F, the engine firmware 220F, and the engine firmware 320F, respectively.

The operation display units 160, 260, and 360 are controlled by the operation display firmware 160F, the operation display firmware 260F, and the operation display firmware 360F, respectively.

The control unit firmware 110F, the control unit firmware 210F, and the control unit firmware 310F as well as the engine firmware 120F, the engine firmware 220F, and the engine firmware 320F are customized according to the difference in function of the three image forming apparatuses 100, 200, and 300, that is to say, the installed firmware is varied among the image forming apparatuses 100, 200, and 300.

The difference includes difference in program module and difference in setting.

On the other hand, the operation display firmware 160F, the operation display firmware 260F, and the operation display firmware 360F are the same firmware.

The image forming apparatuses 100, 200, and 300 each have a data transmission function (see FIG. 3).

However, while the image forming apparatus 100 can use any file format of JPEG, TIFF, PDF, and searchable PDF, the image forming apparatus 200 cannot use the file format of searchable PDF, and the image forming apparatus 300 cannot use the file formats of searchable PDF and PDF.

Each function of the image forming apparatuses 100, 200, and 300 is shown in the model information of the respective image forming apparatuses 100, 200, and 300.

The image forming apparatuses 100, 200, and 300 each have a color printing function.

However, while the image forming apparatus 100 can perform the high-speed monochrome printing of 80 sheets/minute, for example, the image forming apparatuses 200 and 300 can perform the monochrome printing of 40 sheets/minute.

The faxing is enabled only by the image forming apparatus 100 connected to the telephone line.

The BOX function is executable by the image forming apparatuses 100 and 200, but is not imparted to the image forming apparatus 300.

The post-processing is possible only for the image forming apparatus 100.

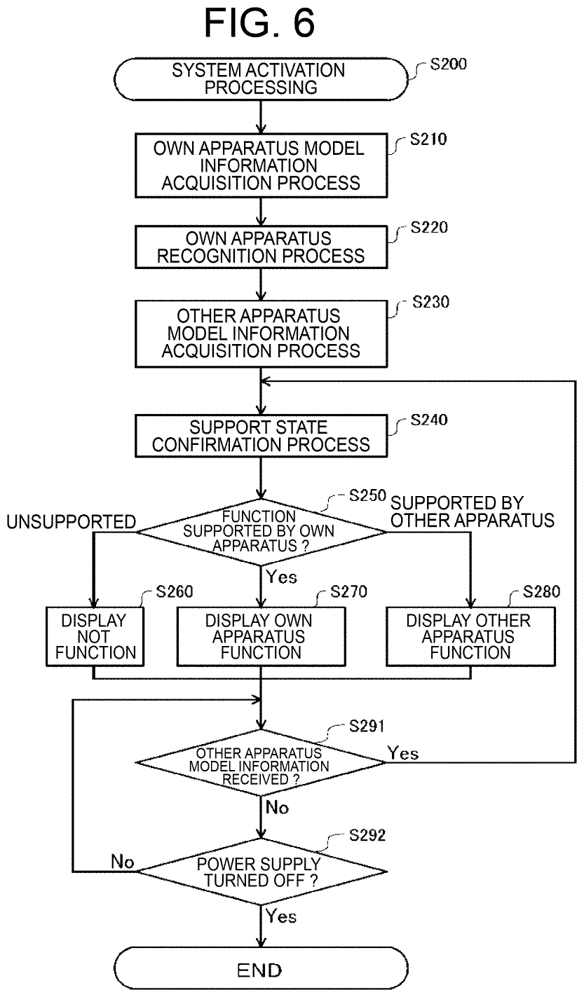

FIG. 6 is a flowchart showing the contents of system activation processing (step S200) according to one embodiment.

In this example, it is assumed that the system activation processing is started in accordance with the power-on of the image forming apparatus 100.

In step S210, the control unit 110 executes an own apparatus model information acquisition process.

In the own apparatus model information acquisition process, the control unit 110 reads out the model information from the model information storage area 142.

In step S220, the control unit 110 executes an own apparatus recognition process.

In the own apparatus recognition process, the control unit 110 confirms the function of the image forming apparatus 100 that is the own apparatus, and transmits the read model information to the other image forming apparatuses 200 and 300.

In step S230, the control unit 110 executes a process for acquiring model information on other apparatuses, namely, an other apparatus model information acquisition process.

In the other apparatus model information acquisition process, the control unit 110 queries the two image forming apparatuses 200 and 300, which are the other apparatuses, about the functions.

The control unit 110 confirms the functions of the other apparatuses based on the respective replies of the two image forming apparatuses 200 and 300.

It is assumed that the model information of the image forming apparatus 200 and the model information of the image forming apparatus 300 (each also referred to as “other apparatus model information”) are included in the respective replies.

In step S240, the control unit 110 executes a support state confirmation process.

In the support state confirmation process, the control unit 110 lists the support state of each function in the three image forming apparatuses 100, 200, and 300, and generates a table L (see FIG. 3).

In step S250, the control unit 110 classifies each of the listed functions into one of “unsupported”, “supported by own apparatus”, and “supported by other apparatus”.

In the case of “unsupported”, the control unit 110 advances to step S260, and in the case of “supported by own apparatus”, the control unit 110 advances to step S270, and in the case of “supported by other apparatus”, the control unit 110 advances the processing to step S280.

In step S260, the control unit 110 does not display the functions which are not supported by any of the three image forming apparatuses 100, 200, and 300.

Thus, the user can recognize only the functions that can be executed by at least one of the plurality of image forming apparatuses that are being started.

In step S270, the control unit 110 executes an own apparatus function display.

In the own apparatus function display, the operation display unit 160 displays a function supported by the own apparatus by using a text display (predetermined display format) set as an initial state.

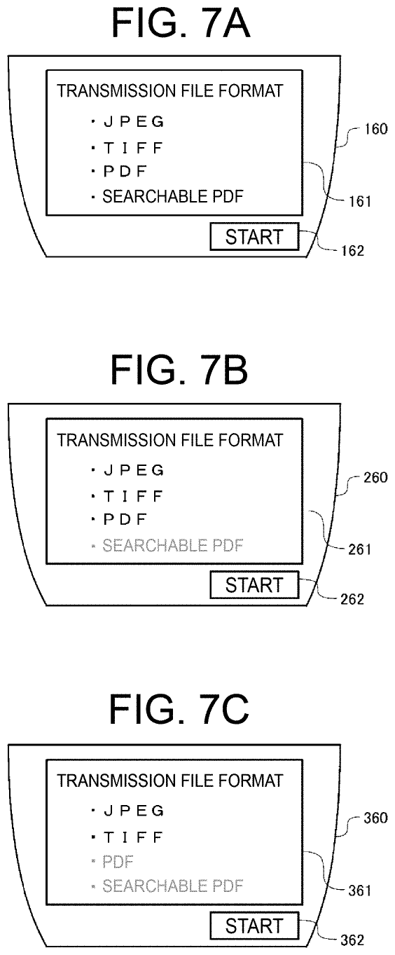

FIGS. 7A to 7C are explanatory diagrams showing the display contents of operation display units 160, 260, and 360 of three image forming apparatuses according to one embodiment.

The operation display units 160, 260, and 360 each show a display state when the data transmission function is selected.

The operation display unit 160 includes a display area 161 and a start icon 162, the operation display unit 260 includes a display area 261 and a start icon 262, and the operation display unit 360 includes a display area 361 and a start icon 362.

FIG. 7A shows the display state of the operation display unit 160 when the data transmission function is selected.

The operation display unit 160 normally displays all of JPEG, TIFF, PDF, and searchable PDF as a transmission file format.

The reason for this is that the functions of JPEG, TIFF, PDF, and searchable PDF are all supported by the image forming apparatus 100 (see FIG. 3).

In step S280, the operation display units 260 and 360 each execute other apparatus function display.

In the other apparatus function display, the operation display units 260 and 360 each display a function in a specific display format different from the PDF or searchable PDF in the initial state.

In this example, the other apparatus function display is set to a gray display with a low density.

A function not executable by the own apparatus but executable by another image forming apparatus is referred to as a proxy possible function.

When the image forming apparatus 100 is activated after the image forming apparatus 300 is activated, the other apparatus model information is acquired according to the activation of the image forming apparatus 100 as the other image forming apparatus (step S210 and step S291), and the display contents of the operation display unit 360 are updated (step S240 to step S280).

Such processing is continued until the power supply to the image forming apparatus 300 is turned off (step S292).

FIG. 7B shows a display state of the operation display unit 260 when the data transmission function is selected.

The operation display unit 260 of the image forming apparatus 200 normally displays the JPEG, TIFF, and PDF as a transmission file format, and displays the searchable PDF in the other apparatus function display.

The reason for this is that the image forming apparatus 200 does not support the searchable PDF data transmission function (see FIG. 3).

FIG. 7C shows a display state of the operation display unit 360 when the data transmission function is selected.

The operation display unit 360 of the image forming apparatus 300 normally displays the JPEG and TIFF as a transmission file format, and displays the PDF and searchable PDF in the other apparatus function display.

The reason for this is that the image forming apparatus 300 does not support the PDF and searchable PDF data transmission functions (see FIG. 3).

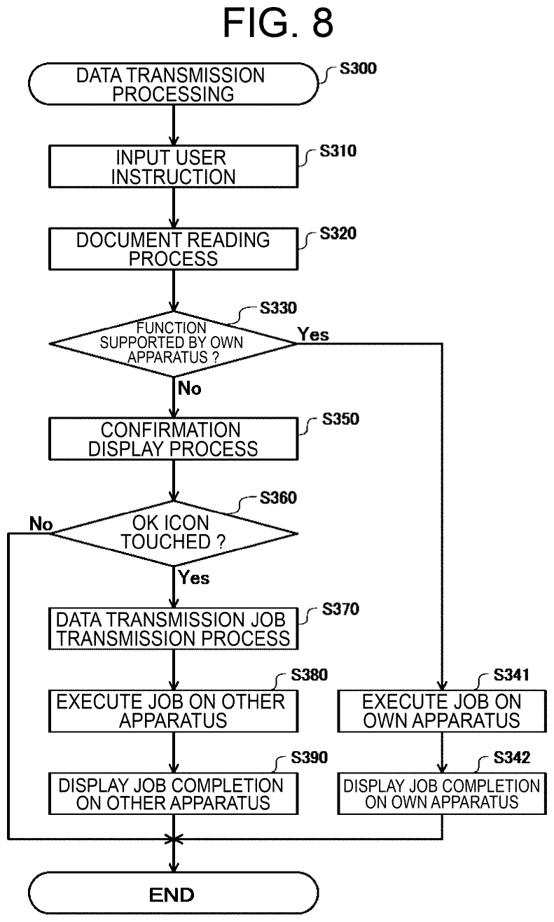

FIG. 8 is a flowchart showing the contents of data transmission processing (step S300) according to one embodiment.

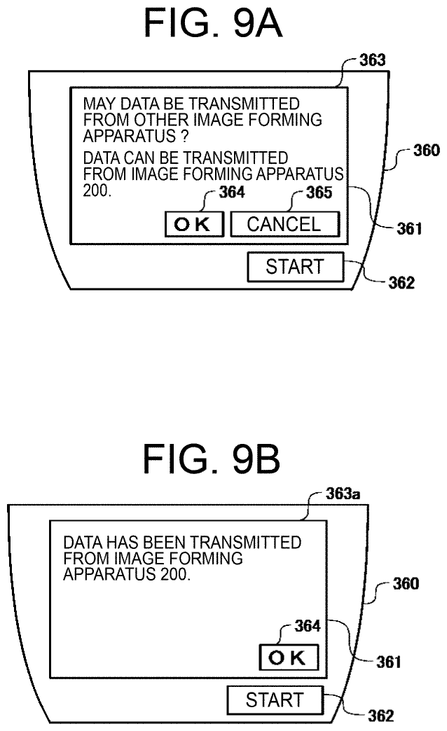

FIGS. 9A and 9B are explanatory diagrams each showing an example of the display contents of the operation display unit 360 that are displayed in data transmission processing according to one embodiment.

In step S310, the operation display unit 360 of the image forming apparatus 300 accepts a user instruction input.

The user instruction input includes a designation of an e-mail address as a destination and a file format.

In this example, it is assumed that the operation display unit 360 accepts the data transmission instruction which includes the selection of the e-mail address registered in advance and indicates that the transmission file format is the PDF format.

In step S320, the operation display unit 360 of the image forming apparatus 300 executes a document reading process.

In the document reading process, an image reading unit (not shown) of the image forming apparatus 300 reads an original image to generate image data.

In step S330, the control unit (not shown) of the image forming apparatus 300 determines whether or not the instructed function is supported by the own apparatus.

When the function is not supported by the own apparatus, the control unit (not shown) of the image forming apparatus 300 advances the processing to step S350.

When the function is supported by the own apparatus and the instruction is input on the image forming apparatus 100, for instance, the control unit 110 executes the job on the own apparatus (step S341), and executes the job completion display (not shown) (step S342).

Specifically, the control unit 110 causes the image reading unit 121 to read the document image to generate the image data ID1, causes the image processing unit 122 to convert the image data ID1 to generate a PDF file, and transmits the PDF file to the e-mail address selected as an attached file of an e-mail.

Thus, the data transmission processing is completed.

In step S350, the operation display unit 360 executes a confirmation display process.

In the confirmation display process, the operation display unit 360 displays the confirmation display screen 363 (see FIG. 9A).

The confirmation display screen 363 indicates that the data transmission processing is to be executed by the image forming apparatus 200 by proxy for the image forming apparatus 300 being operated.

In step S360, when the OK icon 364 is touched on the confirmation display screen 363 of the operation display unit 360, the control unit (not shown) of the image forming apparatus 300 advances the processing to step S370, and ends the processing when the cancel icon 365 is touched.

In step S370, the control unit (not shown) of the image forming apparatus 300 executes a data transmission job transmission process.

In the data transmission job transmission process, the control unit (not shown) of the image forming apparatus 300 first generates a data transmission job.

The data transmission job includes the image data ID1 and the selected e-mail address, and is a job for causing the image forming apparatus 200 to perform data transmission.

A control unit (not shown) of the image forming apparatus 300 transmits a data transmission job to the image forming apparatus 200.

In step S380, a control unit (not shown) of the image forming apparatus 200 acquires the image data ID1 from the data transmission job in response to reception of the data transmission job, converts the image data ID1 to a PDF file, and transmits the PDF file, as an attached file, to the e-mail address acquired from the data transmission job.

The text of the e-mail describes that the image forming apparatus 300 has read the document image and transmitted it from the image forming apparatus 200.

The control unit (not shown) of the image forming apparatus 200 transmits a completion notification to the image forming apparatus 300 according to the completion of the transmission of e-mail.

The image forming apparatus 200 can execute the data transmission processing as concurrent processing (in the background) even when copying is being performed.

Thus, the image forming apparatus 200 attains the proxy execution of data transmission processing without delaying the copying operation of other users.

In step S390, the operation display unit 360 displays a confirmation display screen 363a (see FIG. 9B) in response to reception of the completion notification.

The confirmation display screen 363a indicates that the data transmission processing by the image forming apparatus 200 has been completed.

As described above, the image forming system 10 according to an embodiment of the present disclosure realizes unification of the user interfaces of the three image forming apparatuses 100, 200, and 300, and enables proxy execution of a function instructed on one image forming apparatus by another image forming apparatus on behalf of the one image forming apparatus.

Conventionally, adequate studies have not necessarily been made concerning a method for effectively employing various functions of a plurality of image forming apparatuses of different models to be used while reducing the burden on the use of the functions.

The image forming system 10 makes it possible to employ a function executable by a plurality of image forming apparatuses by unifying the menu configuration among the image forming apparatuses, thereby enabling the user to effectively use the functions of the image forming apparatuses, thus increasing the user convenience.

Since the control program group 400 is configured to be usable in a plurality of image forming apparatuses provided by the supplier of the image forming apparatus 100, the supplier of the image forming apparatus 100 can realize simplification of the driver program, and can quickly cope with environmental changes or the like.

In particular, since the operation display firmware 160F, the operation display firmware 260F, and the operation display firmware 360F are the same (common to the image forming apparatuses 100, 200, and 300), a unified menu configuration can be easily realized.

The present disclosure can be implemented not only in the above-described embodiment but also in the following modifications.

Modification 1: In the above embodiment, the model information is stored in the storage unit 140 of the image forming apparatus 100, but it is not necessarily required to store the model information in the image forming apparatus.

The model information may be acquired from the server via the Internet based on information specifying the model of an image forming apparatus such as the model name of the image forming apparatus.

Modification 2: In the above embodiment, a control program is installed in the three image forming apparatuses 100, 200, and 300 using a common control program group, but the three image forming apparatuses 100, 200, and 300 are not necessarily limited to a configuration in which a control program is installed using a common control program group.

Modification 3: In the above embodiment, the model information stored in the storage unit of each of the three image forming apparatuses 100, 200, and 300 is used, but it is not necessarily required to use the model information stored in the storage unit of the image forming apparatus.

The model information of each image forming apparatus may be managed by a server connected to the network.

Modification 4: In the embodiment described above, the proxy possible function is exemplified by the data transmission function, but the proxy possible function is not limited to the data transmission function.

Specifically, for example, the FAX function is only executable by the image forming apparatus 100 in terms of the apparatus configuration. In the image forming apparatuses 200 and 300, the FAX function is a proxy possible function that is to be executed by the image forming apparatus 100 by proxy.

The post-processing function is only executable by the image forming apparatus 100 in terms of the apparatus configuration. Image data is transmitted from the image forming apparatuses 200 and 300 so that printing and post-processing may be executed by the image forming apparatus 100 by proxy.

The OCR function is only executable by the image forming apparatus 100 in terms of the apparatus configuration. Image data is transmitted from the image forming apparatuses 200 and 300 so that the OCR processing may be executed by the image forming apparatus 100 to receive a reply as a text file.

The proxy possible function includes a function differently specified in quantification.

Specifically, the high-speed monochrome printing differs from the monochrome printing only in the printing speed, but is only executable by the image forming apparatus 100. In the image forming apparatuses 200 and 300, the high-speed monochrome printing is a proxy possible function that is to be executed by the image forming apparatus 100 by proxy.

The proxy possible function also includes a function temporarily restricted in use by the exhaustion of a consumable item or the execution of a calibration.

Specifically, in the image formation processing, when the printing paper is exhausted or when the calibration of the image forming unit 123 is started, a display screen allowing execution by another image forming apparatus by proxy may be displayed.

Modification 5: In the above embodiment, the data transmission job is generated and transmitted to another image forming apparatus to cause the image forming apparatus in question to execute a function by proxy. The method for proxy execution is not limited to the above, and a function may be executed by proxy by remote control of another image forming apparatus.

However, the use of a job such as a data transmission job is advantageous in that the operation of other users is not interfered during the operation of another image forming apparatus.

What is claimed is:

1. An image forming system comprising a plurality of image forming apparatuses connected to each other via a network,
each of the plurality of image forming apparatuses including:
an operation display unit having a menu configuration unified among the plurality of image forming apparatuses; and
a control unit to control the operation display unit,
wherein the operation display unit displays a function executable by at least one of the plurality of image forming apparatuses,
wherein, when processing with a function executable by one image forming apparatus including the operation display unit is instructed, the control unit causes the one image forming apparatus to execute the function, and
wherein, when processing with a function not executable by one image forming apparatus including the operation display unit is instructed, the control unit causes another image forming apparatus capable of executing the function by proxy to execute the function.

2. The image forming system according to claim 1,
wherein each of the plurality of image forming apparatuses further includes a storage unit to store model information indicating a function that is executable by a relevant image forming apparatus, and
wherein the control unit includes a central processing unit and a memory, executes a common control program, and controls operation display of the operation display unit based on the model information.

3. An image forming apparatus connectable to a network, comprising:
an operation display unit having a predetermined menu configuration;
a storage unit configured to store model information indicating a function executable by the image forming apparatus; and
a control unit configured to control the operation display unit,
wherein the control unit:
queries at least one different image forming apparatus connected to the network about model information to specify a proxy possible function that is a function not executable by the image forming apparatus but executable by the at least one different image forming apparatus; and
returns, according to a query from a different image forming apparatus about model information, information indicating a function executable by the image forming apparatus based on the model information, and
wherein the predetermined menu configuration is unified with a menu configuration of an operation display unit of the different image forming apparatus and allows the proxy possible function, which has been specified, to be executed by the at least one different image forming apparatus.

4. The image forming apparatus according to claim 3,
wherein the control unit of the image forming apparatus and a control unit of the different image forming apparatus each include a central processing unit and a memory, each execute a common control program, and control operation display of the operation display units, respectively, based on the model information.

5. The image forming apparatus according to claim 3,
wherein the image forming apparatus transmits, to the different image forming apparatus, a job including data for causing the different image forming apparatus to execute the proxy possible function by proxy.

6. The image forming apparatus according to claim 3,
wherein the operation display unit of the image forming apparatus displays a function executable by the image forming apparatus in a predetermined display format and displays the proxy possible function in a specific display format different from the predetermined display format.

7. An image forming method using an image forming apparatus connectable to a network, comprising:
displaying using a predetermined menu configuration; and
storing model information indicating a function executable by the image forming apparatus,
wherein the displaying includes:
querying at least one different image forming apparatus connected to the network about model information to specify a proxy possible function that is a function not executable by the image forming apparatus but executable by the at least one different image forming apparatus; and
returning, according to a query from a different image forming apparatus about model information, information indicating a function executable by the image forming apparatus based on the model information, and
wherein the predetermined menu configuration is unified with a menu configuration used for displaying on the different image forming apparatus and allows the proxy possible function, which has been specified, to be executed by the at least one different image forming apparatus.

8. A non-transitory computer-readable recording medium that stores a control program for controlling an image forming apparatus connectable to a network,
the control program causing the image forming apparatus to serve as:
an operation display unit having a predetermined menu configuration;
a storage unit to store model information indicating a function executable by the image forming apparatus; and
a control unit to control the operation display unit,
wherein the control unit:
queries at least one different image forming apparatus connected to the network about model information to specify a proxy possible function that is a function not executable by the image forming apparatus but executable by the at least one different image forming apparatus; and
returns, according to a query from a different image forming apparatus about model information, information indicating a function executable by the image forming apparatus based on the model information, and
wherein the predetermined menu configuration is unified with a menu configuration of an operation display unit of the different image forming apparatus and allows the proxy possible function, which has been specified, to be executed by the at least one different image forming apparatus.
